(19) United States
(12) Patent Application Publication
(10) Pub. No.: US 2026/0044774 A1
(43) Pub. Date: Feb. 12, 2026

(54) FOUNDATIONAL MODELS FOR DYNAMIC SYSTEMS

(71) Applicant: INTERNATIONAL BUSINESS MACHINES CORPORATION, ARMONK, NY (US)

(72) Inventors: Kyong Min Yeo, Scarsdale, NY (US); Nam H. Nguyen, Pleasantville, NY (US); MALGORZATA JADWIGA ZIMON, Warrington (GB)

(21) Appl. No.: 18/796,355

(22) Filed: Aug. 7, 2024

(51) Int. Cl. G06N 20/00

(52) U.S. Cl. CPC G06N 20/00

(57) ABSTRACT

An approach for generating time-series dynamic-system training data. The approach may comprise providing a plurality of dynamic systems to a dynamic system dictionary. Where the dynamical system dictionary may comprise a library of functions. The approach may further comprise classifying each of the plurality of dynamic systems. Where classifying may comprise, generating a hierarchical dynamic system data, based on constraint learning, with an encoder and noise generator. The approach may further comprise training a diffusion decoder to generate a time-series segment, based on the classified plurality of dynamical systems. Further, the approach may comprise providing a first time series data segment and generating time-series dynamical training data based on the diffusion decoder using the first time-series data segment as input.

### BACKGROUND

The present invention relates to artificial intelligence and machine learning models, and more specifically, to developing foundational models for dynamic systems.

Physical systems are often dynamic and constantly changing. Measuring these physical system can be a difficult and expensive task. Further, obtaining extended time series data for downstream task prediction is complex and difficult to obtain. It would be advantageous to identify an analogous dynamic system which can best explain the time series data associated with a physical system and utilize the identified dynamic system to study the behaviors of the physical system.

Foundational models are developed in a general sense in the following manner. First data related to the phenomenon of interest is gathered at a large scale. The model is trained using some of the data and rewarded when the model correctly predicts an input correctly. The model is evaluated in this manner until a satisfactory result is obtained. The model can then be utilized as a foundational model in which the pre-trained model is deployed for more specific downstream uses related to the phenomenon of initial interest.

### SUMMARY

According to an embodiment of the present invention, a computer implemented method for generating time-series dynamic-system training data. The computer-implemented method comprises providing a plurality of dynamic systems to a dynamic system dictionary, wherein the dynamical system dictionary comprises a library of functions. The computer-implemented method may further comprise classifying each of the plurality of dynamic systems, wherein classifying comprises generating a hierarchical dynamic system data, based on constraint learning, comprising an encoder and noise generator. Further the computer-implemented method comprises training a diffusion decoder to generate a time-series segment, based on the classified plurality of dynamical systems. Further yet, the computer-implemented method may comprise providing a first time series data segment; and generating time-series dynamical training data based on the diffusion decoder using the first time-series data segment as input.

According to another embodiment of the present invention, a computer system generating time-series dynamic-system training data. The system comprising a memory, and a processor in communication with the memory. Where the processor is configured to perform one or more operations. The operations including to provide a plurality of dynamic systems to a dynamic system dictionary, wherein the dynamical system dictionary comprises a library of functions. Further, operations may include classify each of the plurality of dynamic systems, wherein classifying comprises generating a hierarchical dynamic system data, based on constraint learning, comprising an encoder and noise generator. Operations may also include train a diffusion decoder to generate a time-series segment, based on the classified plurality of dynamical systems. Further yet, operations may include provide a first time series data segment and generate time-series dynamical training data based on the diffusion decoder using the first time-series data segment as input.

Another embodiment of the present invention may include a computer program product for generating time-series dynamic-system training data. The computer program product comprising a computer storage device, and program instructions stored on the computer storage device. The program instructions may include program instructions to provide a plurality of dynamic systems to a dynamic system dictionary, wherein the dynamical system dictionary comprises a library of functions. Also, program instructions to classify each of the plurality of dynamic systems, wherein classifying comprises generating a hierarchical dynamic system data, based on constraint learning, comprising an encoder and noise generator. The embodiment may also include program instructions to train a diffusion decoder to generate a time-series segment, based on the classified plurality of dynamical systems. Further, the embodiment may include program instructions to provide a first time series data segment and program instructions to generate time-series dynamical training data based on the diffusion decoder using the first time-series data segment as input.

### BRIEF DESCRIPTION OF THE DRAWINGS

FIG. 1 is a block diagram depicting an exemplary computing environment, in accordance with an embodiment of the invention.

FIG. 2A is a block diagram depicting an exemplary system for generating dynamic system training data, in accordance with an embodiment of the invention.

FIG. 2B is a block diagram depicting dynamic system training data generation engine 200, in accordance with an embodiment of the invention.

FIG. 3 is a block diagram depicting the steps for generating a time-series training data with a function dictionary 300, in accordance with an embodiment of the invention.

FIG. 4 is a flowchart, depicting the steps of generating dynamic system training data, for a given time series, in accordance with an embodiment of the invention.

### DETAILED DESCRIPTION

Embodiments of the present invention recognize advantages associated with a system or approach for dynamic system foundation models (“DS-FM”). Many times, labelled training data for dynamic systems is scarce. Embodiments of the present invention recognize the need to develop or generate labelled training data from actual samples of the dynamic system, but which have similar dynamics, but are not completely similar as that would lead to overfitting. A DS-FM learns the dynamics of time series data for a dynamic system from a small segment of sample data. Embodiments of the present invention may utilize a dynamic system dictionary of various dynamic systems. In essence, an Al or machine learning model can utilize the dynamic system dictionary to recognize patterns within the segment(s) of sample data to predict behaviors and generate new samples for training a dynamic system prediction model.

Embodiments of the present invention improve upon current technologies in that embodiments can generate new time series data which follow substantially similar dynamics as that of a given input sample. This allows for substantially more time series or dynamic function data which can be used to train predictive models.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure, or characteristic in connection with an embodiment, one skilled in the art has the knowledge to affect such feature, structure or characteristic in connection with other embodiments whether or not explicitly described.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

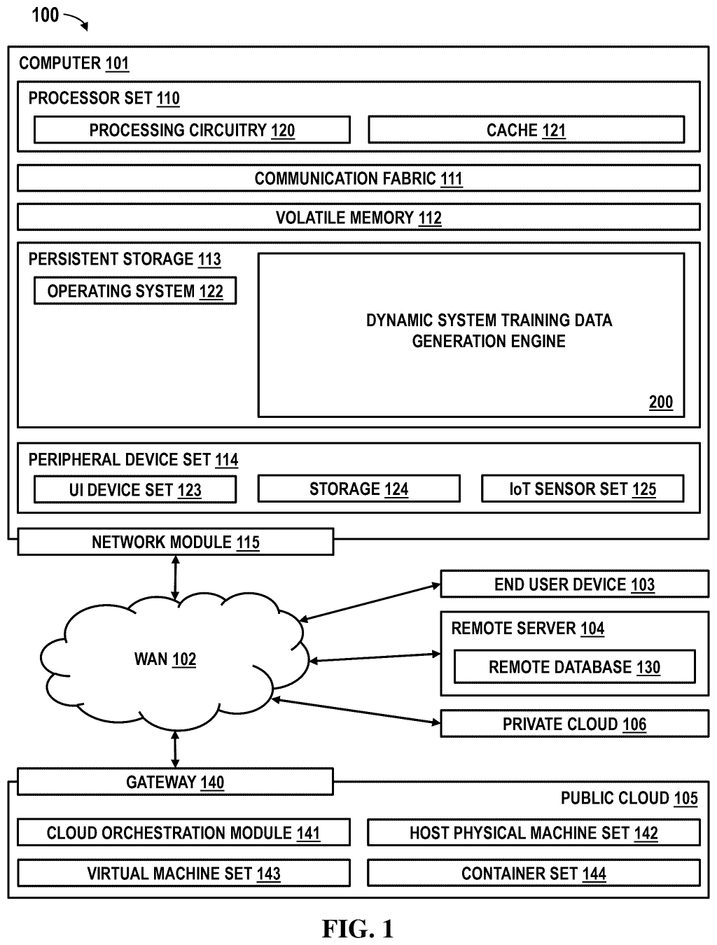

Now with reference to FIG. 1. FIG. 1 is a block diagram depicting an exemplary computing environment, in accordance with an embodiment of the invention. In addition to volumetric object adaptation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and volumetric object adaptation engine 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic system training data generation engine 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in volumetric adaptation engine 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

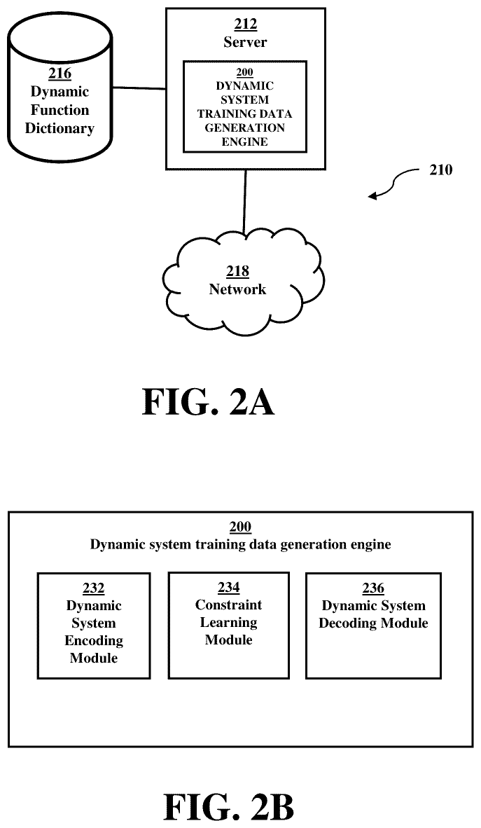

FIG. 2A is a block diagram of computer system 210, in accordance with an embodiment of the invention. As depicted in FIG. 2, computer system 210 comprises: server 212. Operational on server 212 is dynamic system training data generation engine 200 (described in further detail in FIG. 2B). Server 212 is connected to network 218 and dynamic function dictionary 216. Connected to network 218 is virtual reality system 220.

Dynamic Function Dictionary 216 is a databased with multiple functions. The functions can be classified based on dimensions (e.g., 2-D, 3-D, 4-D, . . . etc.). The functions can be based on historical or prior dynamic systems. In an embodiment, the dynamic systems can be known model systems. For example, systems can be Mackey-Glass Time Series, Rossler system, a Van der Pol Oscillator, Lotka-Volterra, Henon-heiles, and Lorenz to name a few. The systems can be stored as a mathematical representation such as vector representations. In an embodiment, the dynamic systems encoding model can be the entity which encodes the functions in dynamic function dictionary 216.

FIG. 2B depicts a block diagram of dynamic system training data generation engine 200. Shown operational on dynamic system training data generation engine 200 is dynamic system encoding module 232, contrastive learning module 234, and dynamic system decoding module 236. In an embodiment, dynamic system training data generation engine 200 can generate dynamic system training data from sample data of the dynamic system. Further, dynamic system training data generation engine 200 can identify a dynamic system that is similar to that of the sample data of the dynamic system from the dynamic function dictionary 216. Further yet, dynamic system training data generation engine 200 can encode sample data from the dynamic system into a mathematical representation. For example, sample physical data from a dynamic system may be provided to dynamic system training data generation engine 200. The sample physical data can be encoded and analyzed by dynamic system training data generation 200. A function with a similar mathematic representation can be identified based on contrastive learning. Using the identified function, training data can be generated from a diffusion decoder where the diffusion decoder uses a random noise together with the mathematical representation of the sample data to generate training data for a downstream purpose, such as a future prediction.

Dynamic system encoding model 232 is a computer module which can receive sample dynamic system data and convert the sample into a mathematical representation. The sample data can be time-series data which encompasses all of the measurements and readings of the dynamic system. The dynamic system may be an industrial production system associated with chemical production or natural gas or oil production. The dynamic system may also be associated with electrical production or electrical grid monitoring. Dynamic system encoding module may be a model comprised of Bi-directional Recurrent Neural Networks (Bi-RNN). In an embodiment, dynamic system encoding module 232 has a particular type of RNN, called gated recurrent units (“GRU”) that control the flow of information between different time steps.

In another embodiment, the RNNs may be in a single or multi-layer architecture and the RNNs may be interconnected within each layer to provide information about each time-series data point in a sample. Multi-layer RNNs are stacked multiple RNN layers on top of each other. This can help improve the performance and capture more complex patterns in sequential data.

Contrastive learning module 234 is a computer module that can be used to identify similar functions within a latent space. In an embodiment, constraint learning module 234 utilizes the following method used in machine learning, particularly for unsupervised learning tasks. It involves teaching a model to learn meaningful representations of data by comparing similar examples closely and pushing apart dissimilar ones. Further, contrastive learning can be utilized by comparing against the dynamic system function dictionary to build a dictionary of dynamical systems. Contrastive representation learning is a method used in machine learning, particularly for unsupervised learning tasks. It involves teaching a model to learn meaningful representations of data by comparing similar examples closely and pushing apart dissimilar ones.

This approach is often used when labeled data is scarce or expensive to obtain. The idea is to train the model on a large dataset where each example consists of two views, such as images of the same object taken at different angles or time series from the same system. By enforcing similar examples to be close and dissimilar ones to be far apart in the learned representation space, the model learns useful features that can later be used for tasks like classification or prediction.

In an embodiment, the contrastive learning module 234 can differentiate multiple dynamic systems within a latent space providing a rich and diverse representation of dynamic systems (e.g., time-series data) so that when provided a sample dynamic system data set, it can be quickly and accurately classified based on its similarity to examples in the learned dictionary. Further, contrastive learning module 234 allows for efficient data compression as well as the ability to generalize to hidden or latent information of dynamic systems. Additionally, this method could potentially enable better understanding of the underlying dynamics of complex systems by analyzing the relationships between different dynamic systems within the learned representation space. To achieve this, the model is trained using a contrastive loss function that encourages similar dynamic systems to have similar representations while pushing apart dissimilar ones. During training, pairs of dynamic systems are sampled and compared based on their similarity. If two time series are considered similar, they will be mapped close together in the learned representation (i.e. latent) space. If they are dissimilar, the model will learn to map them further apart.

In an embodiment, a contrastive learning module 234 may use a contrastive loss as the loss function. In a contrastive loss a data set may comprise three data points, an anchor, a positive, and a negative. The Anchor is the central data point, the one we want the model to focus on. There is a positive, this is a similar data point to the anchor. Finally, there is a negative data point that is different from the anchor. The goal is to pull the anchor and positive data point closer to each other within the embedding space, while pushing the anchor and negative data points further apart from one another. In an embodiment, contrastive loss typically uses a distance metric (like Euclidean distance) to measure the similarity between embeddings. The function penalizes situations where: the distance between the anchor and positive is smaller than the distance between the anchor and negative. Essentially, contrastive loss encourages the model to learn representations where similar things are close together and dissimilar things are far apart. This allows contrastive learning module 234 to focus on Relationships by contrasting examples rather than just labeling them. Further, it is Suitable for Large Datasets: It works well with large unlabeled datasets where obtaining precise labels is difficult.

The trained model can then be used to classify new sample dynamic system data sets by finding their closest neighbors in the learned representation space and making predictions based on their labels. This approach allows for efficient data compression as well as the ability to generalize to unseen systems, making it useful for a variety of applications such as forecasting, control, and system identification in fields like physics, engineering, finance, and biology.

Dynamic System decoding module 236 is a computer program that can decode the learned representation space and generate multiple versions of an input sample dynamic system data set. In an embodiment, dynamic system decoding module 236 can receive the representation of the input data set to decode the encoded sample data set, and generate multiple versions of an input sample dynamic system data set. For example, dynamic system decoding module 236 may be trained via a denoising probabilistic diffusion model. Training of a denoising probabilistic diffusion model consists of forward and reverse diffusion processes. In the forward diffusion process, a clean sample data set is progressively corrupted by the addition of gaussian noise for multiple steps, until the data set becomes pure noise. Then, in the reverse diffusion process, the denoising probabilistic diffusion model is trained to retrieve the original data from the pure noise. Dynamic system decoding module 236 learns to predict the noise that was added at each step, essentially learning how to reverse the diffusion process. This leads to Dynamic system decoding module 236 possessing the capability to generate dynamical system data from a random noise. For example, when provided the representation of a sample data, dynamic system decoding module 236 first merges the representation with a random noise and then iteratively reduces the noise through the reverse diffusion process. This continues until a clean data set is reconstructed. The outcome allows for generative capabilities, whereby starting with pure noise and iteratively denoising it, diffusion models can generate new, unseen data samples.

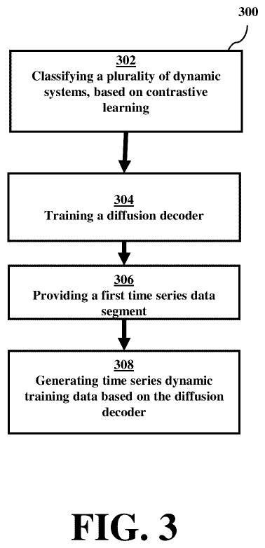

With reference now to FIG. 3. FIG. 3 is flowchart depicting the steps of the invention and is generally designated as 300. At step 302. contrastive learning module 234 can classify a plurality of dynamic system, based on contrastive learning. For example, contrastive learning can determine the embeddings of the functions within dynamic function dictionary.

At step 304, train a diffusion decoder. For example, dynamic system decoding module can be trained with the functions from dynamic function dictionary 216. The functions can gradually have noise added to the functions, and the noise can be cleared up by dynamic system decoding module 216, over multiple iterations, until a satisfactory result is returned (i.e., the dynamic function looks as it did before noise was added). Further, the dynamic system decoding module 236 can receive the dynamic functions as encodings and be required to decode the noisy encodings back to the original functions.

At step 306, a first time series data segment can be provided to dynamic system encoding module 232. For example, a time-series data set for a dynamic system, such as an industrial chemical paint mixing system. The time-series can be comprised of multiple data points in different modes and measurements, such as temperature, pressure, weight, spectroscopy readings, etc.

At step 308, dynamic system training data generation engine 200 can generate a plurality of dynamic system training data based on the provided time-series data set. For example, the provided data set can be encoded by dynamic system encoding module 232. The encodings can be compared against the dynamic functions in dynamic function dictionary 216 by contrastive learning module 234. Once a similar dynamic function has been identified. Dynamic system decoding module 216 can generate a plurality of data points from the encodings using random noise.

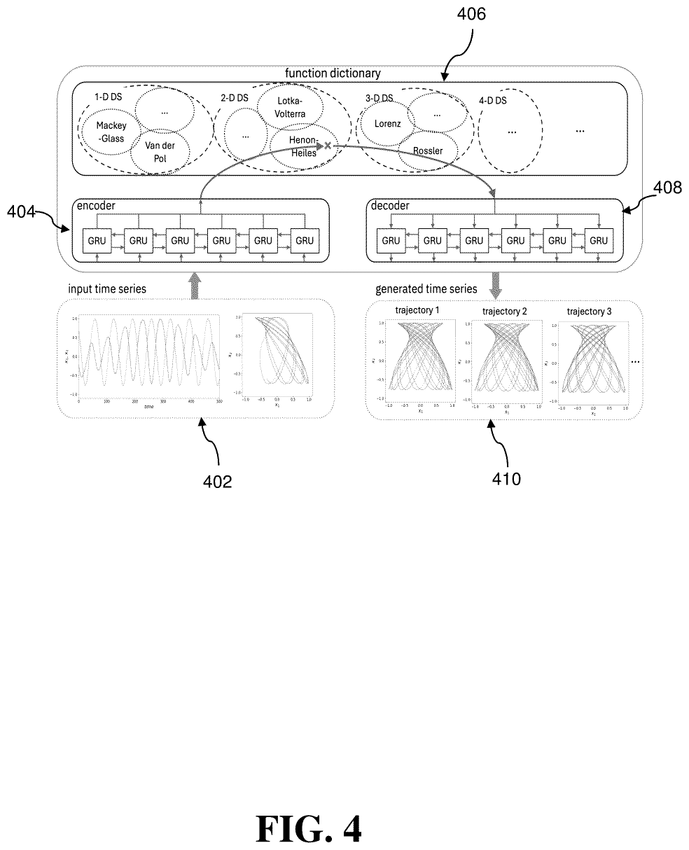

FIG. 4 is a block diagram of the flow of information through an exemplary embodiment of the present invention, generally designated 400. 402 shows an exemplary input time series of a dynamic system. 404 shows an example embodiment of an architecture of dynamic system encoding module 232. The reader will note the single layer of GRUs that are interconnected. This is for exemplary purposes as there may be more layers of GRUs and/or more GRUs within a layer. 406 shows a simplified embedding with the dynamic functions of the dynamic function dictionary. In 406, contrastive learning module 234 would determine or compare the embeddings of the input time-series to that of the embeddings of the dynamic function dictionary to classify the input time-series. 408 shows an example architecture of dynamic system decoding module 236. At 408, dynamic system decoding module 236 can receive the embeddings and classification and generate new sample time-series 410 to train a time-series prediction model (not shown).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The computer-implemented method comprising, providing a plurality of dynamic systems to a dynamic system dictionary, wherein the dynamical system dictionary comprises a library of functions. Classifying each of the plurality of dynamic systems, wherein classifying comprises generating a hierarchical dynamic system data, based on constraint learning, and comprising an encoder and noise generator. Training a diffusion decoder to generate a time-series segment, based on the classified plurality of dynamical systems. Providing a first time series data segment and generating time-series dynamical training data based on the diffusion decoder using the first time-series data segment as input.

Embodiments of the computer-implemented method may also include the dynamical system dictionary being based on classifications of a number of dimensions of an associated system.

Embodiments of the computer-implemented method may further include aspects where classifying each of the plurality of dynamic system further comprises, receiving an input time series. Encoding the input time series based on a plurality of recurrent neural networks, wherein the input time series is encoded into a multi-dimensional vector. Determining a first similar dynamic system against the encoded input time series from the dynamic system dictionary, based on contrastive learning and decoding the input time series, based on a plurality of recurrent neural network decoding units.

Embodiments of the computer-implemented method may further include aspects where the diffusion decoder uses the representation of sample data and random noise to generate time-series dynamic training data.

Embodiments of the computer-implemented may further include aspects where the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

Embodiments of the computer-implemented method may further include aspects where the first time series data segment is a physical system.

Embodiments of the computer-implemented method may further include aspects where the encoding is further based on a multi-layer bi-directional gated recurrent unit.

Further, embodiments of the present invention may include a computer system for generating time-series dynamic-system training data, where the system comprises a memory, and a processor in communication with the memory. The processor can be configured to perform operations. The operations may include provide a plurality of dynamic systems to a dynamic system dictionary, wherein the dynamical system dictionary comprises a library of functions. Operations may also include classify each of the plurality of dynamic systems, where classifying comprises generating a hierarchical dynamic system data that is based on constraint learning and comprises an encoder and noise generator. Operations may also include train a diffusion decoder to generate a time-series segment where it is based on the classified plurality of dynamical systems. The operations may include provide a first time series data segment and. generate time-series dynamical training data based on the diffusion decoder using the first time-series data segment as input.

Embodiments of the computer system may include aspects where the dynamical system dictionary is based on classifications of a number of dimensions of an associated system.

Embodiments of the computer system may include aspects where classifying each of the plurality of dynamic system further comprises operations including receive an input time series, encode the input time series based on a plurality of recurrent neural networks, wherein the input time series is encoded into a multi-dimensional vector, determine a first similar dynamic system against the encoded input time series from the dynamic system dictionary, based on contrastive learning, and decode the input time series, based on a plurality of recurrent neural network decoding units.

Embodiments of the computer system may include aspects where the diffusion decoder uses the representation of sample data and random noise to generate time-series dynamic training data.

Embodiments of the computer system may include aspects where the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

Embodiments of the computer system may include aspects where the first time series data segment is a physical system.

Embodiments of the computer system may include aspects where the encoding is further based on a multi-layer bi-directional gated recurrent unit.

Further, embodiments of the present invention may include a computer program product for generating time-series dynamic-system training data. Where the computer program product comprises a computer storage device, and program instructions stored on the computer storage device. The program instructions comprise, program instructions to provide a plurality of dynamic systems to a dynamic system dictionary, where the dynamical system dictionary comprises a library of functions, program instructions to classify each of the plurality of dynamic systems, where classifying comprises generating a hierarchical dynamic system data, based on constraint learning, comprising an encoder and noise generator, program instructions to train a diffusion decoder to generate a time-series segment, based on the classified plurality of dynamical systems, program instructions to provide a first time series data segment, and program instructions to generate time-series dynamical training data based on the diffusion decoder using the first time-series data segment as input.

Embodiments of the computer program product may include aspects where the dynamical system dictionary is based on classifications of a number of dimensions of an associated system.

Embodiments of the computer system may include aspects where classifying each of the plurality of dynamic system further comprises program instructions to receive an input time series, program instructions to encode the input time series based on a plurality of recurrent neural networks, wherein the input time series is encoded into a multi-dimensional vector, program instructions to determine a first similar dynamic system against the encoded input time series from the dynamic system dictionary, based on contrastive learning, and program instructions to decode the input time series, based on a plurality of recurrent neural network decoding units.

Embodiments of the computer program product may include aspects where the diffusion decoder uses the representation of sample data and random noise to generate time-series dynamic training data.

Embodiments of the computer program product may include aspects where the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

Embodiments of the computer program product may include aspects where the first time series data segment is a physical system.

What is claimed is:

1. A computer-implemented method for generating time-series dynamic-system training data, the approach comprising:
providing a plurality of dynamic systems to a dynamic system dictionary, wherein the dynamical system dictionary comprises a library of functions;
classifying each of the plurality of dynamic systems, wherein classifying comprises generating a hierarchical dynamic system data, based on constraint learning, comprising an encoder and noise generator;
training a diffusion decoder to generate a time-series segment, based on the classified plurality of dynamical systems;
providing a first time series data segment; and
generating time-series dynamical training data based on the diffusion decoder using the first time-series data segment as input.

2. The computer-implemented method of claim 1, wherein the dynamical system dictionary is based on classifications of a number of dimensions of an associated system.

3. The computer-implemented method of claim 1, wherein classifying each of the plurality of dynamic system further comprises:
receiving an input time series;
encoding the input time series based on a plurality of recurrent neural networks, wherein the input time series is encoded into a multi-dimensional vector;
determining a first similar dynamic system against the encoded input time series from the dynamic system dictionary, based on contrastive learning; and
decoding the input time series, based on a plurality of recurrent neural network decoding units.

4. The computer implemented method of claim 1, wherein the diffusion decoder uses the representation of sample data and random noise to generate time-series dynamic training data.

5. The computer-implemented method of claim 1, wherein the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

6. The computer-implemented method of claim 1, wherein the first time series data segment is a physical system.

7. The computer-implemented method of claim 3, wherein the encoding is further based on a multi-layer bi-directional gated recurrent unit.

8. A computer system for generating time-series dynamic-system training data, the system comprising:
a memory; and
a processor in communication with the memory, the processor being configured to perform operations to:
provide a plurality of dynamic systems to a dynamic system dictionary, wherein the dynamical system dictionary comprises a library of functions;
classify each of the plurality of dynamic systems, wherein classifying comprises generate a hierarchical dynamic system data, based on constraint learning, comprising an encoder and noise generator;
train a diffusion decoder to generate a time-series segment, based on the classified plurality of dynamical systems;
provide a first time series data segment; and
generate time-series dynamical training data based on the diffusion decoder using the first time-series data segment as input.

9. The computer system of claim 8, wherein the dynamical system dictionary is based on classifications of a number of dimensions of an associated system.

10. The computer system of claim 8, wherein classifying each of the plurality of dynamic system further comprises:
receive an input time series;
encode the input time series based on a plurality of recurrent neural networks, wherein the input time series is encoded into a multi-dimensional vector;
determine a first similar dynamic system against the encoded input time series from the dynamic system dictionary, based on contrastive learning; and
decode the input time series, based on a plurality of recurrent neural network decoding units.

11. The computer system of claim 8, wherein the diffusion decoder uses the representation of sample data and random noise to generate time-series dynamic training data.

12. The computer system of claim 8, wherein the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

13. The computer system of claim 8, wherein the first time series data segment is a physical system.

14. The computer system of claim 8, wherein the encoding is further based on a multi-layer bi-directional gated recurrent unit.

15. A computer program product for generating time-series dynamic-system training data, the computer program product comprising a computer storage device, and program instructions stored on the computer storage device, wherein the program instructions comprise:
program instructions to provide a plurality of dynamic systems to a dynamic system dictionary, wherein the dynamical system dictionary comprises a library of functions;
program instructions to classify each of the plurality of dynamic systems, wherein classifying comprises generating a hierarchical dynamic system data, based on constraint learning, comprising an encoder and noise generator;
program instructions to train a diffusion decoder to generate a time-series segment, based on the classified plurality of dynamical systems;
program instructions to provide a first time series data segment; and
program instructions to generate time-series dynamical training data based on the diffusion decoder using the first time-series data segment as input.

16. The computer program product of claim 15, wherein the dynamical system dictionary is based on classifications of a number of dimensions of an associated system.

17. The computer program product of claim 15, wherein classifying each of the plurality of dynamic system further comprises:
program instructions to receive an input time series;
program instructions to encode the input time series based on a plurality of recurrent neural networks, wherein the input time series is encoded into a multi-dimensional vector;
program instructions to determine a first similar dynamic system against the encoded input time series from the dynamic system dictionary, based on contrastive learning; and
program instructions to decode the input time series, based on a plurality of recurrent neural network decoding units.

18. The computer program product of claim 8, wherein the diffusion decoder uses the representation of sample data and random noise to generate time-series dynamic training data.

19. The computer program product of claim 8, wherein the dynamic systems dictionary is comprised of a set of a large number of dynamical systems with a varying dimensionality, for example, a set comprising Rossler system, Mackey-Glass time series, Van der Pol system, Lorenz system, Lotka-Volterra system, and Henon Heiles system.

20. The computer program product of claim 8, wherein the first time series data segment is a physical system.
